(19) United States
(12) Patent Application Publication
(10) Pub. No.: US 2019/0346065 A1
(43) Pub. Date: Nov. 14, 2019

(54) MULTIVALVE MEMBER FLOW CONTROL APPARATUS AND METHOD

(71) Applicants: Francis R. Byle, Hubertus, WI (US); Brett G. Berger, Hartford, WI (US); Andrew Paul Biehl, Oconomowoc, WI (US); Christopher J. Kujawski, Waukesha, WI (US)

(72) Inventors: Francis R. Byle, Hubertus, WI (US); Brett G. Berger, Hartford, WI (US); Andrew Paul Biehl, Oconomowoc, WI (US); Christopher J. Kujawski, Waukesha, WI (US)

(73) Assignee: TLX Technologies, LLC, Pewaukee, WI (US)

(21) Appl. No.: 16/407,928

(22) Filed: May 9, 2019

Related U.S. Application Data
(60) Provisional application No. 62/670,136, filed on May 11, 2018.

(51) Int. Cl. F16K 99/00; F16K 15/02; F16K 31/06

(52) U.S. Cl. CPC F16K 99/0028; F16K 31/0651; F16K 15/026

(57) ABSTRACT

A solenoid operated valve constructed in accordance with the teachings herein utilizes multiple solenoids which each actuate their own respective valve member. There is a one-to-one relationship of valve members to solenoids. This same one-to-one relationship exists between the valve members and a plurality of passages arranged along a flow path through the valve. Each solenoid is operable to independently move its associated valve member from a closed position, where the valve member is seated against a partition wall defining the passage to entirely prevent fluid flow through its associated passage (or only allow for a controlled leakage flow), and an open position, where the valve member allows fluid flow through its associated passage.

### CROSS-REFERENCE TO RELATED PATENT APPLICATIONS

This patent application claims the benefit of U.S. Provisional Patent Application No. 62/670,136, filed May 11, 2018, the entire teachings and disclosure of which are incorporated herein by reference thereto.

### FIELD OF THE INVENTION

This invention generally relates to valves, and more particularly to solenoid operated valves.

### BACKGROUND OF THE INVENTION

Contemporary proportional control valves have the advantage of providing a broad range of control settings (e.g. output flow rates) by varying the flow coefficient of a single valve opening along a flow path through the valve. This variation may be so fine that a near infinite number of control settings along a continuous curve are possible for a given valve. This variation of the flow coefficient may be done by varying the linear or rotary position of a valve member arranged within the valve opening along the flow path. Examples of such linear variation may be seen from spool valves, while examples of such rotary variation may be seen in butterfly valves.

While such valves have proven suitable for proportional control, they are not without drawbacks. Indeed, standard proportional valves which are solenoid actuated will exhibit hysteresis when moving from one control setting to another. Such hysteresis results in non-linear changes in flow, and can lead to system unpredictability. Further, because the aforementioned proportional valves vary flow coefficients via the position and orientation of the valve member along the flow path, the geometry of the valve member must be relatively precise, which drives the cost of such valves up. Still further, such proportional solenoid valves require constant application of electrical current to hold the same in their desired position.

Accordingly, there is a need in the art for a solenoid operated valve which overcomes the above deficiencies. The invention provides such a solenoid operated valve. These and other advantages of the invention, as well as additional inventive features, will be apparent from the description of the invention provided herein.

### BRIEF SUMMARY OF THE INVENTION

In one aspect, the invention provides a solenoid operated valve. An embodiment of such a solenoid operated valve includes a housing having an internal cavity divided into an inlet portion and an outlet portion by a partition wall. At least one inlet of the housing is in communication with the inlet portion to allow entry of fluid into the inlet portion. At least one outlet is in communication with the outlet portion to allow fluid to exit the outlet portion. A plurality of passages extend through the partition wall to communicate the inlet portion with the outlet portion such that a flow path extends from the at least one inlet to the at least one outlet through the housing. A plurality of valve members are respectively associated with the plurality of passages such that each valve member is operable to allow or prevent fluid flow through each passage, respectively. A plurality of solenoids are respectively associated with the plurality of valve members such that each solenoid is operable to move each valve member such that the valve member allows or prevents fluid flow through each passage, respectively.

In certain embodiments according to this aspect, each one of the plurality of solenoids has an armature, and the armatures are arranged in parallel to one another. In other embodiments according to this aspect, each one of the plurality of solenoids has an armature, and at least two of the armatures are arranged non-parallel to one another. In certain embodiments according to this aspect, at least one of the plurality of solenoids is a latching solenoid or a peak and hold solenoid. The plurality of solenoids may be configured and arranged for both independent actuation relative to one another and simultaneous actuation relative to one another.

In certain embodiments according to this aspect, the plurality of passages each have the same flow area. In other embodiments according to this aspect, at least one of the plurality of passages has a flow area that is different than the flow areas of at least one other one of the plurality of passages.

In certain embodiments according to this aspect, the plurality of solenoids are respectively associated with the plurality of valve members such that each solenoid is operable to move each valve member to transition the valve from a closed position to a fully open position in a step-wise arrangement.

In another aspect, the invention provides a solenoid operated valve. An embodiment of such a solenoid operated valve includes a housing having at least one inlet and at least one outlet in communication with an internal cavity of the housing. A flow path extends from the at least one inlet to the at least one outlet through the housing. A plurality of valve members are arranged along the flow path and commonly disposed within the internal cavity. A plurality of solenoids are respectively associated with the plurality of valve members such that each solenoid is operable to move each valve member from a closed position where the valve member prevents a portion of the flow along the flow path through valve, and an open position wherein the valve member permits a portion of the flow along the flow path through the valve. Each solenoid is operable to independently move its associated valve member from the closed position to the open position to step-wise increase a flowrate of fluid at the at least one outlet, or from the open position to the closed position to step-wise decrease the flowrate of fluid at the at least one outlet.

In certain embodiments according to this aspect, each one of the plurality of solenoids has an armature, and the armatures are arranged in parallel to one another. In other embodiments according to this aspect, each one of the plurality of solenoids has an armature, and at least two of the armatures are arranged non-parallel to one another. In certain embodiments according to this aspect, at least one of the plurality of solenoids is a latching solenoid or a peak and hold solenoid. The plurality of solenoids may be configured and arranged for both independent actuation relative to one another and simultaneous actuation relative to one another.

In certain embodiments according to this aspect, the housing has an internal cavity divided into an inlet portion and an outlet portion by a partition wall. The at least one inlet of the housing is in communication with the inlet portion to allow entry of fluid into the inlet portion. The at least one outlet is in communication with the outlet portion to allow fluid to exit the outlet portion. A plurality of passages extend through the partition wall to communicate the inlet portion with the outlet portion.

In certain embodiments according to this aspect, the plurality of valve members are respectively associated with the plurality of passages such that each valve member is operable to allow or prevent fluid flow through each passage, respectively, and wherein the plurality of solenoids are respectively associated with the plurality of valve members such that each solenoid is operable to move each valve member such that the valve member allows or prevents fluid flow through each passage, respectively.

In certain embodiments according to this aspect, the plurality of passages each have the same flow area. In other embodiments according to this aspect, at least one of the plurality of passages has a flow area that is different than the flow areas of at least one other one of the plurality of passages.

In yet another aspect, the invention provides a method of operating a solenoid operated valve. The solenoid operated valve comprises a housing having at least one inlet and at least one outlet in communication with an internal cavity of the housing. A flow path extends from the at least one inlet to the at least one outlet through the housing. A plurality of valve members are arranged along the flow path and commonly disposed within the internal cavity. A plurality of solenoids are respectively associated with the plurality of valve members such that each solenoid is operable to independently move its associated valve member from a closed position where the valve member prevents a portion of the flow along the flow path through valve, and an open position wherein the valve member permits a portion of the flow along the flow path through the valve. An embodiment of a method according to this aspect includes transitioning, in a first transitioning step, a first one of the plurality of valve members from the open position to a closed position, or from the closed position to the open position.

In certain embodiments according to this aspect, the method includes transitioning, in a second transitioning step, a second one of the plurality of valve members from the open position to the closed position or from the closed position to the open position sequentially after the first transitioning step.

In certain embodiments according to this aspect, the first and second transitioning steps include transitioning the first and second valve members within an inlet portion of the internal cavity of the housing, the inlet portion separated from an outlet portion of the internal cavity by a partition wall having a plurality of passages extending through said partition wall.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a solenoid operated valve according to the teachings herein;

FIG. 2 is a cross section of the embodiment of FIG. 1, in an open position;

FIG. 3 is a cross section of the embodiment of FIG. 1, in a closed position;

FIG. 4 is a perspective view of another embodiment of a solenoid operated valve according to the teachings herein;

FIG. 5 is a cross section of the embodiment of FIG. 4, in an open position;

FIG. 6 is a cross section of the embodiment of FIG. 4, in a closed position;

FIG. 7 is a perspective view of another embodiment of a solenoid operated valve according to the teachings herein;

FIG. 8 is a cross section of the embodiment of FIG. 7, in an open position;

FIG. 9 is a cross section of the embodiment of FIG. 7, in a closed position;

FIG. 10 is a table illustrating the various flow possibilities of an embodiment of a solenoid operated valve according to the teachings herein; and

FIG. 11 is another cross section of a solenoid operated valve according to the teachings herein.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

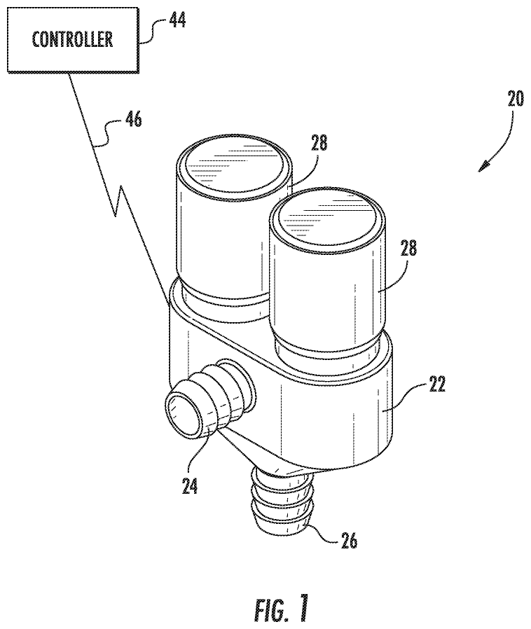

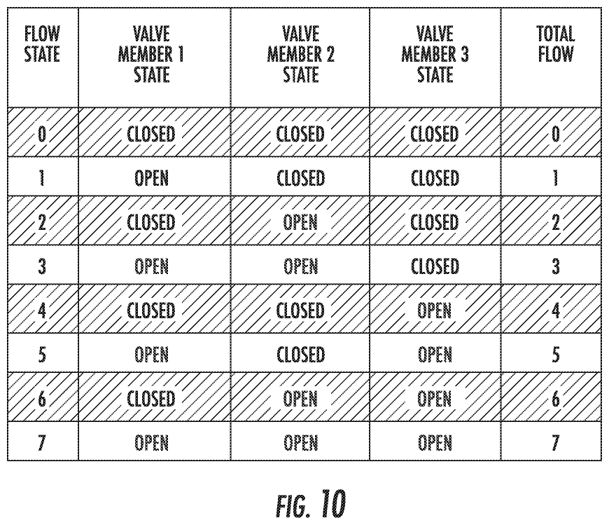

Turning now to the drawings, FIGS. 1-9 illustrate several different embodiments of a solenoid operated valve (also referred to herein simply as a valve) according to the teachings herein. FIG. 10 illustrates an example of the various incremental flow values which are possible using a solenoid operated valve constructed in accordance with the teachings herein.

As will be understood from the following, a solenoid operated valve constructed in accordance with the teachings herein utilizes multiple solenoids which each actuate their own respective valve member. In other words, there is a one-to-one relationship of valve members to solenoids. This same one-to-one relationship exists between the valve members and a plurality of passages arranged along a flow path through the valve. Each solenoid is operable to independently move its associated valve member from a closed position, where the valve member is seated against a partition wall defining the passage to entirely prevent fluid flow through its associated passage (or only allow for a controlled leakage flow), and an open position, where the valve member allows fluid flow through its associated passage.

As a result of the above introduced independent state change possibilities for each valve member, the flowrate at the outlet of the valve may be increased or decreased incrementally in a step-wise fashion. Those of skill in the art will readily understand that the term “step-wise” as used herein means that the flowrate may be changed in a series of distinct stages or steps, discontinuously. Such functionality allows the valve to deliver various output flowrates for varying system demands.

Such a system and functionality may, for non-limiting example, be employed in a cooling system where various distinct flowrates of coolant are needed for system operation. In such a cooling system, it is not necessary to have a flowrate curve which is continuous. In other words, in such a system, a cooling flowrate of X is desirable in one mode of operation, while a cooling flowrate of 2X is desirable in another mode of operation. A cooling flowrate between X and 2X is not desirable in such a system, so the ability to continuously vary flowrate along a curve as is done by preexisting proportional valves is not necessary. Because such continuous proportional control is eliminated, so too are the drawbacks discussed above, including hysteresis and precision machined valve members.

Turning now to FIG. 1, the same illustrates an embodiment of a valve 20. Valve 20 includes a housing 22. Housing 22 defines an inlet 24 and outlet 26. The terms “inlet” and “outlet” used throughout this application are done so for orientation only as the embodiments described herein contemplate bi-directional flow. A flow path extends between inlet 24 and outlet 26 through housing 22.

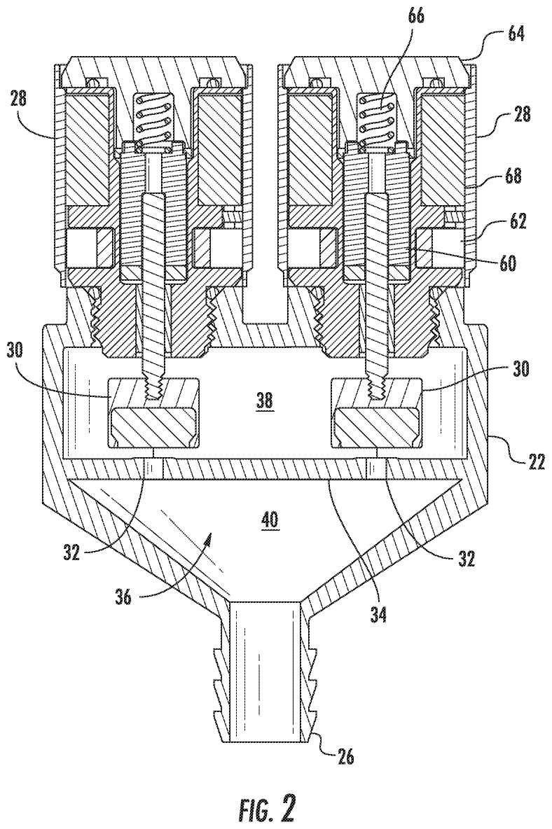

Two identical solenoids 28 are mounted to an exterior of housing 22. As will be explained in greater detail below, each solenoid 28 moves a valve member 30 (see FIG. 2) to open and close a passage 32 (see FIG. 2) within an internal cavity of housing 22. As briefly introduced above, opening and closing passages 32 increases or decreases a flowrate at outlet 26. Solenoids 28 may be latching solenoids. Latching solenoids have the advantage of reducing the electrical power supplied to each solenoid to hold each valve member in its open or closed state to zero, or nearly zero. It is also conceived that solenoids 28 could be embodied as peak and hold type solenoids, which as appreciated by those of skill in the art, utilize a drive circuit which applies a higher current to the solenoid while it is at its open position than when it is at its closed position.

Still referring to FIG. 1, a controller 44 may also be associated with valve 20, as well as the other valve embodiments described herein. Controller 44 may be connected to each solenoid 28 via a wired or wireless connection, which are collectively shown as connection 46. In the case of wireless connection, the valves described herein will be connected to a separate power supply. In such an instance, controller 44 may, for example, separately control the provided by the separate power supply to the valves. Of course, which such a configuration, the valves can employ any conventional wireless communication hardware, firmware, and software to communicate wirelessly with controller 44. Such embodiments may also include sensors for detecting solenoid armature position, and hence valve member state, i.e. opened or closed.

In the case of a wired connection, controller 44 may be mounted directly to the valves described herein, or be a stand-alone controller located remotely from the valves. Such a controller 44 may be embodied by a conventional master controller responsible for controlling the power supplied to a variety of devices. As one example, controller 44 may be an engine control unit (ECU) of an automobile. Whether wired or wireless, solenoids 28 only require electrical power input, so the valves described herein may be readily dropped into an existing system which already includes its own controller.

Turning now to FIG. 2, as already mentioned solenoids 28 may be latching solenoids. A brief description of one solenoid 28 will be provided in the following. That description applies equally well to all solenoids referenced herein. As those of ordinary skill in the art can readily appreciate, latching solenoids leverage magnetic force to reduce or entirely eliminate the electrical power required to hold an armature 60 of the solenoid in a given position. Solenoids 28, when embodied as latching solenoids, may be permanent magnet type latching solenoids or residual magnetism type latching solenoids, or any combination thereof. Further, solenoids 28 could also be of the peak and hold type introduced above.

Indeed, a permanent magnet 62 induces a magnetic field which biases armature 60 into magnetic contact with a pole piece 64. The magnetic attraction between these components is strong enough to overcome the biasing force provided by a biasing element 66 acting against armature 60. However, energizing a coil 68 of solenoid 28 momentarily reduces the strength of this field, allowing biasing element 66 to move armature 60 away from pole piece 64. Upon de-energizing coil 68, the magnetic field of permanent magnet 62 is not strong enough to overcome the biasing force provided by biasing element 66. Applying a current to coil 62 in the opposite direction, however, strengthens this field and thus returns armature 66 to its contact with pole piece 64. Of course, in the case of a residual magnetism type latching solenoid, permanent magnet 62 is omitted and latching is achieved via the use of a short pulse of electrical current, which introduces a magnetic field force between armature 60 and pole piece 64. Permanent magnet 62 would also be omitted in the instance of a peak and hold type solenoid construction.

The above introduced valve members 30 are connected to each armature 60 in a one-to-one relationship. Each valve member 30 may be of one piece construction, such as a rubber stopper-like element, or alternatively, be a multi-piece construction and include more rigid materials but carry a sealing component such as a rubber disc for providing an axial seal.

Each valve member 30 axially seals against a partition wall 34 of housing 22. Partition wall 34 is situated within an internal cavity 36 of housing 22. Partition wall 34 divides internal cavity 36 into an inlet portion 38, and an outlet portion 40. Inlet portion 38 is in fluid communication with inlet 24, while outlet portion 40 is in fluid communication with outlet 26. Fluid flow between inlet and outlet portions 38, 40 is only possible through passages 32. Each valve member 30 is associated with one flow passage 32.

As a result, the flowrate from inlet chamber 38 to outlet chamber 40, and hence inlet 24 to outlet 26, is entirely dependent upon the positions of valve members 30. In FIG. 2, valve 20 may be considered to be shown in a fully open position, as both valve members 30 are in the open position. As a result, the maximum possible total flow area is presented to the flow between inlet chamber 38 and outlet chamber 40. The phrase “flow area” as used herein means the cross sectional area of each passage 32 which is normal to the direction of flow through passage 32.

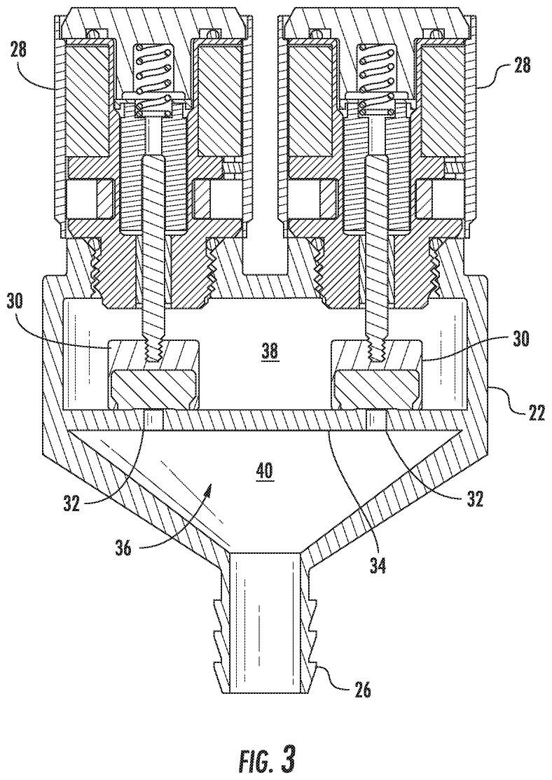

With both valve members 30 in the open position as is shown in FIG. 2, the maximum possible total flow area, i.e. the combined flow areas of all passages 32, is available. Turning now to FIG. 3, in contrast, with both valve members 30 in the closed position such that they axially seal against partition wall 34, all flow between inlet chamber 38 and outlet chamber 40 is prevented, and hence there is no flow between inlet 24 and outlet 26. As indicated above, each valve member 30 is independently movable from the others. As such, with only one valve member in the open position, a flowrate less than that possible by the configuration of FIG. 2 is achieved.

While passages 32 are illustrated as having identical flow areas, it is possible for passages 32 to differ between on another with respect to their flow areas. For example, one passage 32 may have a flow area of X, while another passage has a flow area of 2X. Such a configuration allows for achieving a variety of different flowrates using valve members 30.

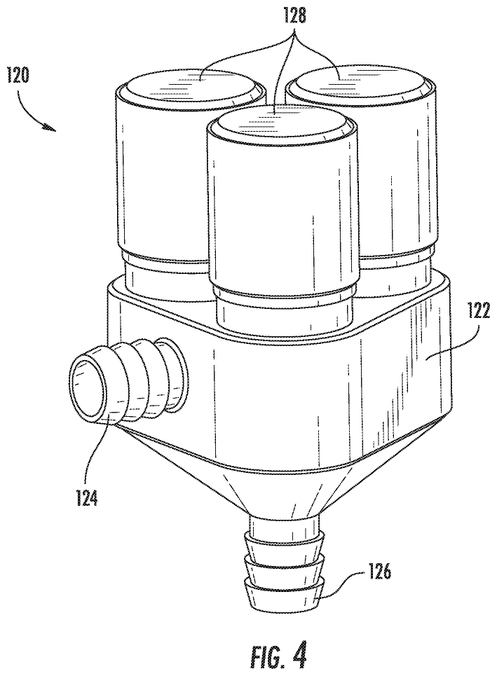

Turning now to FIGS. 4-6, another embodiment of a valve 120 is illustrated. This valve 120 differs from valve 20 described above in that it incorporates three solenoids 128 instead of two (and thus an equal number of valve members 130 and passages 132) to control flow between in inlet 124 and outlet 126 of housing 122. Valve 120 may also function with a controller as described above.

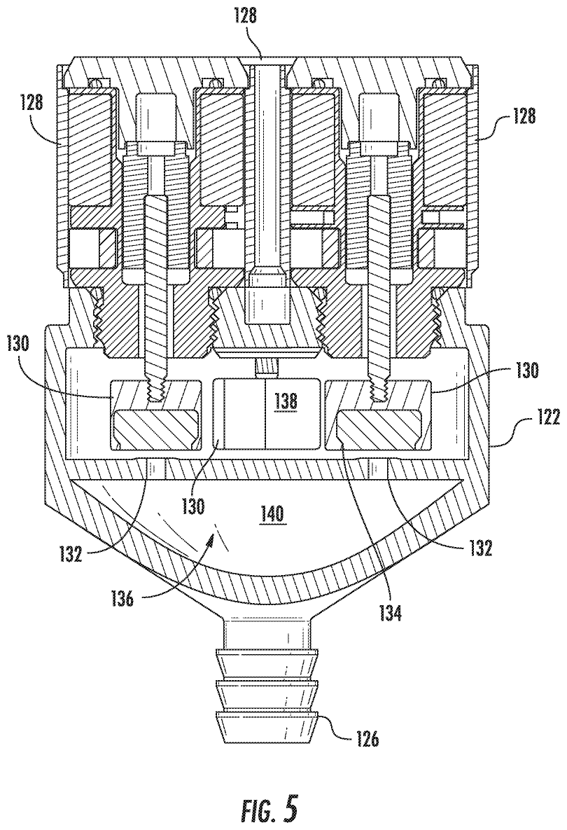

With particular reference to FIG. 5, valve 120 includes partition wall 134 which provides passages 132 and divides an internal cavity 136 into an inlet portion 138 and an outlet portion 140. Inlet portion 138 communicates with inlet 124, and outlet portion 140 communicates with outlet 126.

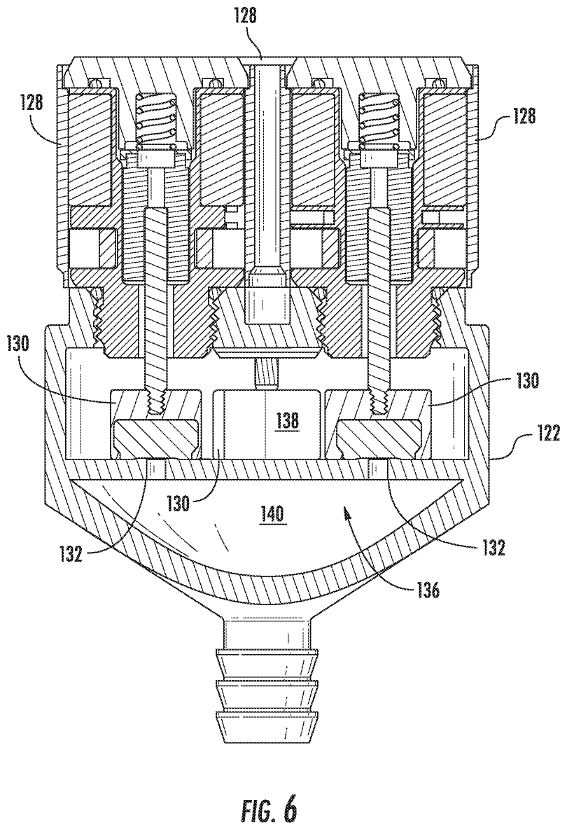

In the same manner as that described above, valve members 130 may be independently actuated by solenoids 128 to move the same from their open positions shown in FIG. 5 to their closed positions shown in FIG. 6. Also in the same manner as described above, passages 132 may have non-identical flow areas to govern the various flow rates possible depending upon which valve members are in the open position.

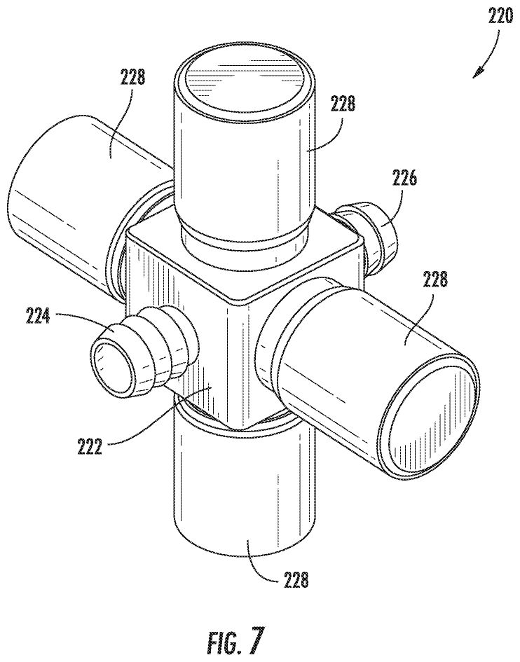

Turning now to FIGS. 7-9, another embodiment of a valve 220 is illustrated. This valve 220 differs from valves 20, 120 described above in that it incorporates four solenoids 228 instead of two or three (and thus an equal number of valve members 230 and passages 232) to control flow between in inlet 224 and outlet 226 of housing 222. Valve 220 may also function with a controller as described above.

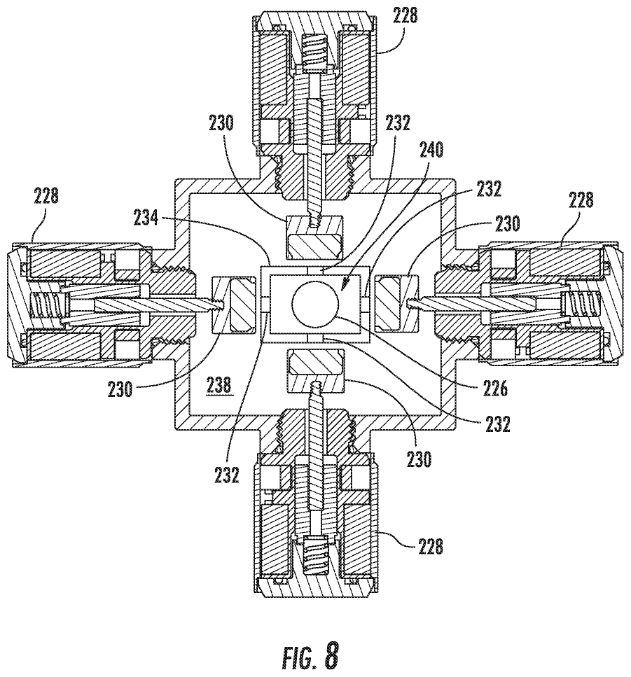

With particular reference to FIG. 8, valve 220 includes a partition wall 234 which provides passages 232 and divides an internal cavity 236 into an inlet portion 238 and an outlet portion 240. Inlet portion 238 communicates with inlet 224, and outlet portion 240 communicates with outlet 226.

As may be surmised in the view of FIG. 8, partition wall 234 in this instance is provided by a non-planar wall which defines a rectangular outer periphery. Outlet chamber 240 is bounded by this rectangular outer periphery. This feature may be formed by a rectangular channel which extends from the interior side of outlet 226 to the opposite wall of internal cavity 236 such that flow cannot pass from inlet portion 238 to outlet portion 240 without passing through passages 232.

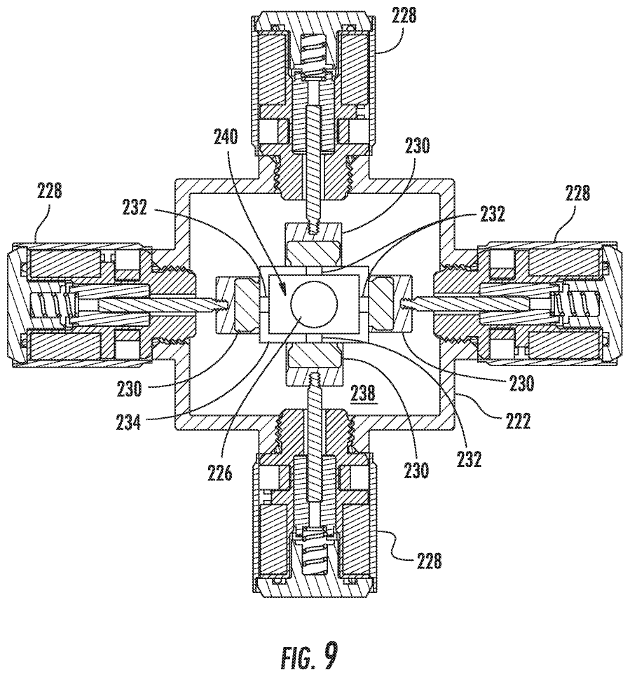

In the same manner as that described above, valve members 230 may be independently actuated by solenoids 228 to move the same from their open positions shown in FIG. 8 to their closed positions shown in FIG. 9. Also in the same manner as described above, passages 232 may have non-identical flow areas to govern the various flow rates possible depending upon which valve members are in the open position.

Turning now to FIG. 10, the same illustrates a table which defines the various possible flows for a valve constructed in accordance with the teachings herein. This particular valve is similar to that shown in FIGS. 4-6 in that it is a three-solenoid valve. As such, there are three valve members, and three passages. In this example, the passages are scaled relative to one another such that they provide different flow areas. Indeed, the passage associated with valve member 1 provides a flowrate of 1 generic volume per unit time, the passage associated with valve member 2 provides a flow rate of 2 generic volume per unit time, and the passage associated with valve member 3 provides a flow of 4 generic volume per unit time. As result, the various valve members may be actuated to change their states to achieve a variety of different combined flows of generic volume units per unit time, as reflected in the right most column of the table.

In a method of operating the valve providing the flows in accordance with that shown in FIG. 10, a first transitioning step would transition valve member 1 from closed to open, thereby allowing a total flow of 1 generic volume unit per unit time. In a second transitioning step, valve member 1 may return to the closed position, and valve member 2 may move from closed to open, to allow for a total flow of 2 generic volume per unit time. It should be noted that the flow states shown in FIG. 10 need not be progressed through sequentially. For example, after moving valve member 1 to its open position to achieve flow state 1, it is possible to move directly to flow state 3 by moving valve member 2 to its open position thus leaving only valve member 3 in the closed position.

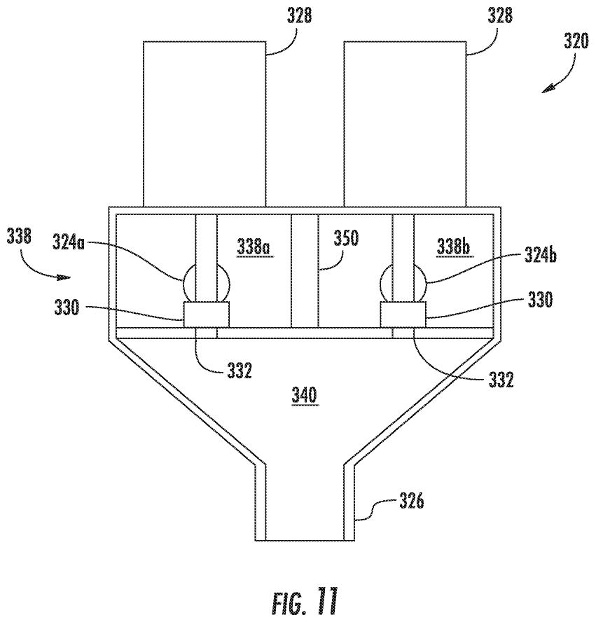

Other features are also contemplated relative to the valves described herein. Although single inlet/single outlet embodiments are shown, it is also contemplated that a valve constructed in accordance with the teachings herein could have multiple inlets and/or multiple outlets. Indeed, with reference to FIG. 11, the teachings herein could be embodied as a solenoid operated valve 320 serving as a mixing valve as is shown in cross section in FIG. 11. Such an embodiment utilizes solenoids 328 as defined herein which are each associated with a valve member 330. Each valve member 330 is in turn associated with a passage 332. Each valve member is movable between a closed position and an open in the same manner as described above.

However, rather than having a single inlet and a single outlet, this embodiment employs multiple inlets 324a, 324b which are associated with an inlet portion 338 divided into sub-chambers 338a, 338b, respectively. These sub-chambers 338a, 338b are separated by a divider wall 350 as shown. In such a configuration, different material types may flow into each sub-chamber 338a, 338b, and opening the valve member 330 of each chamber will mix these materials in the outlet portion 340. Each sub-chamber may include more than one valve element 330 (and hence more passages 332 associated with that sub-chamber), so that various mixing concentration may be achieved.

As another feature, rather the valves may have a designed in minimum leakage flow. This may be achieved by manipulating the seal interface of each valve member with its associated passage such that, when the valve member is in the closed position, a minimum leakage flow is still, permitted. Further, each passage may include ridges, chamfers, or any other geometry to achieve a desired seal with its associated valve member.

As yet another feature, although each solenoid moves a single valve member in the embodiments shown, it is also contemplated that multiple valve members could attach to a single armature.

As yet another feature, it is also contemplated that the solenoids described herein could provide pilot operation of the valve members. Indeed, each solenoid could open a passage in the same fashion as described above, but instead of that passage leading to the outlet, it could instead lead to another chamber within which a valve element carrying the valve member is disposed. The pressure provided by opening the above passage could be used to actuate this valve element which would in turn move the associated valve member from an open to a closed position or vice versa relative to a passage which ultimately leads to an outlet portion. The inlet portion in such a configuration could be the space in which pilot fluid flow enters as well as the space containing the above mentioned valve elements.

As such, the internal cavity of the housing would still be divided into an inlet portion and an outlet portion which are separated by a partition wall having a plurality of passages. In the same functional configuration as described above, each solenoid would be associated with each valve member carried by each valve element such that operation of the solenoid would result in movement of the valve member to open and close passages between the inlet portion and the outlet portion.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non- claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A solenoid operated valve, comprising:
a housing having an internal cavity divided into an inlet portion and an outlet portion by a partition wall, wherein at least one inlet of the housing is in communication with the inlet portion to allow entry of fluid into the inlet portion, and wherein at least one outlet is in communication with the outlet portion to allow fluid to exit the outlet portion, wherein a plurality of passages extend through the partition wall to communicate the inlet portion with the outlet portion such that a flow path extends from the at least one inlet to the at least one outlet through the housing;
a plurality of valve members respectively associated with the plurality of passages such that each valve member is operable to allow or prevent fluid flow through each passage, respectively; and
a plurality of solenoids respectively associated with the plurality of valve members such that each solenoid is operable to move each valve member such that the valve member allows or prevents fluid flow through each passage, respectively.

2. The solenoid operated valve of claim 1, wherein each one of the plurality of solenoids has an armature, and the armatures are arranged in parallel to one another.

3. The solenoid operated valve of claim 2, wherein each one of the plurality of solenoids has an armature, and at least two of the armatures are arranged non-parallel to one another.

4. The solenoid operated valve of claim 1, wherein at least one of the plurality of solenoids is a latching solenoid or a peak and hold type solenoid.

5. The solenoid operated valve of claim 1, wherein the plurality of solenoids are configured and arranged for both independent actuation relative to one another and simultaneous actuation relative to one another.

6. The solenoid operated valve of claim 1, wherein the plurality of passages each have the same flow area.

7. The solenoid operated valve of claim 1, wherein at least one of the plurality of passages has a flow area that is different than the flow areas of at least one other one of the plurality of passages.

8. The solenoid operated valve of claim 1, wherein the plurality of solenoids are respectively associated with the plurality of valve members such that each solenoid is operable to move each valve member to transition the valve from a closed position to a fully open position in a step-wise arrangement.

9. A solenoid operated valve, comprising:
a housing having at least one inlet and at least one outlet in communication with an internal cavity of the housing, wherein a flow path extends from the at least one inlet to the at least one outlet through the housing;
a plurality of valve members arranged along the flow path and commonly disposed within the internal cavity; and
a plurality of solenoids respectively associated with the plurality of valve members such that each solenoid is operable to move each valve member from a closed position where the valve member prevents a portion of the flow along the flow path through valve, and an open position wherein the valve member permits a portion of the flow along the flow path through the valve, wherein each solenoid is operable to independently move its associated valve member from the closed position to the open position to step-wise increase a flowrate of fluid at the outlet, or from the open position to the closed position to step-wise decrease the flowrate of fluid at the outlet.

10. The solenoid operated valve of claim 9, wherein each one of the plurality of solenoids has an armature, and the armatures are arranged in parallel to one another.

11. The solenoid operated valve of claim 10, wherein each one of the plurality of solenoids has an armature, and at least two of the armatures are arranged non-parallel to one another.

12. The solenoid operated valve of claim 9, wherein at least one of the plurality of solenoids is a latching solenoid or a peak and hold solenoid.

13. The solenoid operated valve of claim 9, wherein the plurality of solenoids are configured and arranged for both independent actuation relative to one another and simultaneous actuation relative to one another.

14. The solenoid operated valve of claim 9, wherein the valve housing has an internal cavity divided into an inlet portion and an outlet portion by a partition wall, wherein the at least one inlet of the housing is in communication with the inlet portion to allow entry of fluid into the inlet portion, and wherein the at least one outlet is in communication with the outlet portion to allow fluid to exit the outlet portion, wherein a plurality of passages extend through the partition wall to communicate the inlet portion with the outlet portion.

15. The solenoid operated valve of claim 14, wherein the plurality of valve members are respectively associated with the plurality of passages such that each valve member is operable to allow or prevent fluid flow through each passage, respectively, and wherein the plurality of solenoids are respectively associated with the plurality of valve members such that each solenoid is operable to move each valve member such that the valve member allows or prevents fluid flow through each passage, respectively.

16. The solenoid operated valve of claim 14, wherein the plurality of orifices each have the same flow area.

17. The solenoid operated valve of claim 14, wherein at least one of the plurality of passages has a flow area that is different than the flow areas of at least one other one of the plurality of passages.

18. A method of operating a solenoid operated valve, the solenoid operated valve comprising a housing having at least one inlet and at least one outlet in communication with an internal cavity of the housing, wherein a flow path extends from the at least one inlet to the at least one outlet through the housing, a plurality of valve members arranged along the flow path and commonly disposed within the internal cavity, and a plurality of solenoids respectively associated with the plurality of valve members such that each solenoid is operable to independently move its associated valve member from a closed position where the valve member prevents a portion of the flow along the flow path through valve, and an open position wherein the valve member permits a portion of the flow along the flow path through the valve, the method comprising transitioning, in a first transitioning step, a first one of the plurality of valve members from the open position to a closed position, or from the closed position to the open position.

19. The method of claim 18, further comprising transitioning, in a second transitioning step, a second one of the plurality of valve members from the open position to the closed position or from the closed position to the open position sequentially after the first transitioning step.

20. The method of claim 19, wherein the first and second transitioning steps include transitioning the first and second valve members within an inlet portion of an internal cavity of the housing, the inlet portion separated from an outlet portion of the internal cavity by a partition wall having a plurality of passages extending through said partition wall.
